(19) United States
(12) Patent Application Publication
(10) Pub. No.: US 2021/0264498 A1
(43) Pub. Date: Aug. 26, 2021

(54) ADAPTABLE SYSTEMS AND METHODS FOR MATCHING AVAILABLE CLOTHING TO APPROPRIATE CUSTOMERS BASED ON PROFILE DATA

(71) Applicant: Jennifer Stine, Brentwood, TN (US)

(72) Inventor: Jennifer Stine, Brentwood, TN (US)

(21) Appl. No.: 17/183,152

(22) Filed: Feb. 23, 2021

Related U.S. Application Data
(60) Provisional application No. 62/980,950, filed on Feb. 24, 2020.

(51) Int. Cl. G06Q 30/06

(52) U.S. Cl. CPC G06Q 30/0631; G06Q 30/0625; G06Q 30/0641; G06Q 30/0621

(57) ABSTRACT

Systems and methods are described for serving clients by having the client measure some favorite clothing items to develop a clothing fit profile that is a better way for a consumer to seek out clothing purchases both online and offline. Using measurements from articles of clothing also removes the anxiety many people feel about measuring their own bodies when clothing shopping. Ultimately, this type of data allows for completely personalized shopping to be available to users, whether they prefer to shop on or offline.

This application claims the benefit under 35 U.S.C. 119(e) of the filing date of Provisional U.S. Application Ser. No. 62/980,950, entitled Adaptable Systems and Methods for Matching Available Clothing to Appropriate Customers Based on Profile Data, filed on Feb. 24, 2020, which application is expressly incorporated herein by reference, in its entirety.

### BACKGROUND OF THE INVENTION

The present invention is related to clothing, and more particularly to systems and methods for providing an on-demand personal clothing shopping catalog, as well as a “matching” and “finder” service that will send notifications to consumers with active profiles about clothing for sale that meets their data profile requirements. The ultimate result is a personal, on-demand, shopping catalog which is custom-curated according to each user's fit profile data.

While online clothing shopping is a growing industry, the fit of clothing is still difficult to determine using standard industry data. The fact of the matter is that clothing sizing is not standard across the industry and consumer body profiles are highly individualized. Very few consumers are “off the rack” shoppers. For many consumers, then, online clothing shopping becomes a frustrating exercise in ordering clothing, hoping it will fit, awaiting its arrival, trying it on, and then returning much of it and requesting refunds for the returned articles. In-store shopping is equally difficult, with consumers enduring many trial and error fitting room experiences. The return and refund process is laborious and time consuming, heightened by the frustration that the purchasing process must begin again.

As discussed above, industry standard clothing sizing is very unreliable for determining individual customer fit. Online services to help consumers find better “style” are available, and made-to-order clothing based on customer measurements and online services to find resale clothing have also emerged in the changing landscape of the clothing industry, but no one has successfully addressed the core issues of how to help a consumer define and identify THEIR actual need and specific fit preferences to then be able to make the most accurate recommendations possible. Existing online clothing ordering involves simply the offering of clothing identified by standard sizing schemes and affiliate marketing, wherein an online influencer or service business will make a recommendation to their audience of consumers to purchase an item online and provides an “affiliate link” so their referral will be attributed the sale and they will make a percentage commission on the sale of that item. There is currently an application called MTailor, targeted at male consumers for custom clothing production, there is Measure & Fit custom fit clothing made to order, there are subscription clothing styling platforms such as StitchFix, and there are many platforms for consumers to buy and sell resale/used clothing, such as Ebay, Poshmark, and ThredUP, but the inventor knows of no businesses using the measurement of consumer clothes that fit as desired in combination with body measurements to determine best fit and/or make purchase recommendations. In this invention, actual consumer body measurements are optional, but when provided may serve as the single source of data for matching, or may be used to refine fit recommendations to the consumer. No retailer, manufacturer or database resource is currently making outbound notifications to consumers regarding the discovery of items for purchase, based on consumer fit profiling comparisons to clothing or body measurements. The only types of data comparisons being made are manufacturer data to manufacturer data comparisons to inform retailers about buying trends and sizing similarities. Consumers are not receiving notifications that help them determine their “size” across brands. There is currently no process by which a consumer may receive personalized clothing recommendations across brands and “sizes” related to measurement data of any kind.

The present invention addresses one or more or all of the needs mentioned above.

### SUMMARY OF THE INVENTION

The present invention comprises systems and methods for serving clients by having the client measure some favorite clothing items to develop a clothing fit profile that is a better way for a consumer to seek out clothing purchases both online and offline. Using measurements from articles of clothing also removes the anxiety many people feel about measuring their own bodies when clothing shopping. Ultimately, this type of data allows for completely personalized shopping to be available to users, whether they prefer to shop on or offline.

In addition to individual personalized fit profiles, as discussed above, the inventive systems and methods collect and utilize crowdsourced data regarding clothing currently available in brick-and-mortar stores. With the collection of sufficient crowdsourced data, it becomes possible to create a very robust, personalized shopping catalog for each user, available on-demand, at their fingertips, and with the ability to reset preferences and refresh the personalized catalog at any time. Thus, the systems and methods of the invention utilizes personal favorites clothing data as a first data level. This data can, at a consumer's option, be combined with personal bodily measurements in order to improve the matches obtained by processing the data. The aforementioned crowdsourced data improves the generated clothing matches as well, and this crowd-sourced data may be made available to clothing manufacturers and retailers to produce clothing offerings that are far more attuned to consumers' actual needs and desires.

This invention also facilitates informing a consumer of specific size variances, such as “Ann Taylor Size 8” is equal to “Calvin Klein Size 10”. There is no service or data analytics provider known to the inventor using outbound communications of any kind to facilitate a consumer knowledge base being available or an ability to purchase recommendations in this way.

More particularly, there is disclosed herein a method for providing a user with a selection of available articles which most closely match a set of criteria provided by the user. The inventive method comprises steps of providing to a user an input interface identifying a set of criteria to be used to develop the selection of available articles, collecting data responsive to the set of criteria and input by the user in the input interface and establishing a user profile therefrom, comparing the user profile to data in a database regarding available articles, selecting particular ones of the available articles which most closely match the data in user profile, and preparing and transmitting to the user a communication concerning the selection of available articles. In some applications of the method, the articles comprise articles of clothing.

The recited set of criteria may comprise a set of specified measurements and sizing information for the articles of clothing and/or the body of a user, but may also comprise, for example, one or more of reduced prices for articles of a specific brand, from a specific store or chain of stores, or from a combination of previously matched items, and/or one or more specific article brands. The set of criteria may also comprise a plurality of article brands sourced from a particular store or chain of stores.

The input interface may be displayed on a screen of a personal computer or communications device, and the communication may be transmitted to the user by push notifications through a mobile phone application, text, email, or via an alert message on a website account.

In the case where the set of criteria comprises a set of specified measurements and sizing information for the articles of clothing and/or the body of a user, the set of specified measurements and sizing information may include one or more of favorite clothing item measurements or sizes and body measurements. Body measurements may comprise, for example, a distance between a user's armpit across their upper arm, a distance from armpit-to-armpit on a user, a cuff size for a user, a distance from shoulder to front hem for a user, a distance from shoulder to back hem for a user, a bottom hem width, and a measurement for sleeve inseam. For pants and shorts, there may be a measurement for rise, hip, thigh, knee, bottom hem width, and shorts inseam. For dresses and jumpers, there may be shoulder to hem, and any or all measurements listed above.

Other body/clothing measurements useful in the described method include a neck width measurement for a user, an ankle bottom width measurement for a user, an ankle bottom width measurement for a user, a waist to bottom hem measurement for a user, a shoulder to bottom hem front measurement for a user, a shoulder to bottom hem back measurement for a user, measurement of a user's widest section of the breast, a specific band measurement under bust to back size for a user, a specific band height measurement for a user, and a specific measurement across a widest part of a leg opening for a user.

Crowdsourcing data from a plurality of users may be used to populate the database. In addition, data may be collected from market sources of the articles, such as manufacturers, stores, or distributors, to populate the database.

The invention, together with additional features and advantages thereof, may best be understood by reference to the following description taken in conjunction with the accompanying illustrative drawings.

### BRIEF DESCRIPTION OF THE DRAWINGS

FIG. 1 is a summary of database profiles used in the inventive systems and methods for comparison and for generating results and clothing recommendations to a user; and

FIG. 2 illustrates an example of methodology utilized to generate suitable additional clothing measurements for the database used in the inventive systems and methods.

### DETAILED DESCRIPTION OF THE INVENTION

The invention reinvents the approach a consumer takes when looking for clothing purchases, in an innovative way. Currently, as noted above, a consumer is forced to “hunt” through a very time-consuming trial-and-error process for articles of clothing that fits in a way the consumer likes, and to identify clothing brands that most consistently fit their body proportions. The massive inconsistency in current sizing presentation to consumers is archaic and impractical. Turning clothes shopping into a data-matching process, as in the present invention, provides consumers with a powerful and pleasurable shopping experience, with more options, more styles to choose from, and personalized recommendations based on how they like things to fit—not a predetermined size. Additionally, although the present focus of the invention is the curation of a personalized sale catalog based on a consumer's profile information with respect to fit, such catalogs may also be curated for reduced rate purchases from a specific brand, store, or a combination of previously matched items, based on brand-specific preferences of the consumer, or store-specific preferences of the consumer with multiple brands, for both new and resale clothing.

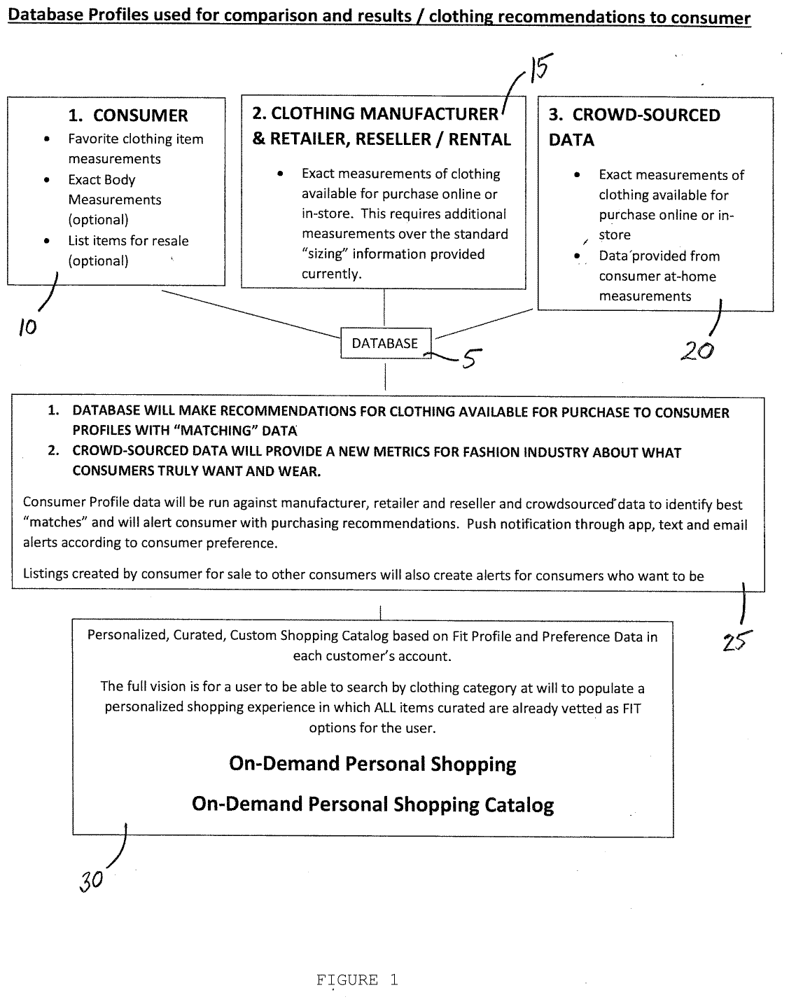

FIG. 1 illustrates an example according to the principles of the present invention, of a consumer profile created with favorite clothing measurements, optional body measurements, and other preferences, which allow a database 5 to identify best options for the consumer and take away the most frustrating part of searching for clothing options. As indicated in the first box 10, the consumer may also optionally list items for resale. This data is stored in the illustrated database 5, as shown. The second box 15 permits clothing manufacturers, retailers, and resellers or rental companies to populate the database 5, in the event they wish to make their inventory available for matching in order to promote sales of their clothing products. Their participation requires data, in the form of additional measurements, beyond the standard sizing currently provided to consumers. As noted above, any data entered by such entities is also transferred to the illustrated database 5.

The third box 20 illustrates the entry into the database 5 of crowd-sourced data, which comprises exact measurements of clothing available for purchase online or in-store, those measurements being the same as are input in the first two boxes 10, 15, as well as the data provided from consumer at-home measurements, after it has been rendered anonymous by being scrubbed of any identification to particular consumers. This crowd-sourced data can be utilized for analysis, and industry reporting is inevitably created. This valuable data, aggregated for the first time ever, provides true insight into consumer preferences for clothing size and fit. Incentives may be employed to encourage users to supply this data, or to permit their submitted data to be used in this way in accordance with applicable data privacy laws, including waived or reduced application fees, reduced subscription, membership, or service fees, special pricing, and the like. Many industry brands and segments will use this data to improve their product offerings. This data, also, is transferred to the database 5, as illustrated.

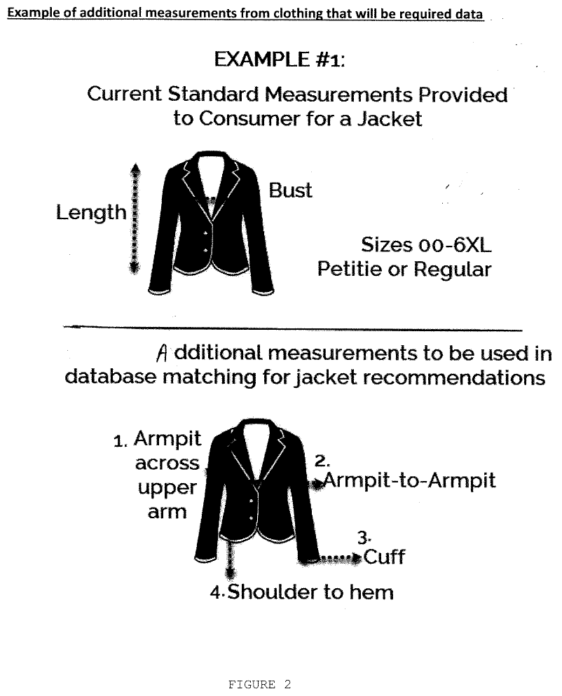

FIG. 2 illustrates exemplary, but not necessarily exhaustive, clothing measurements for use in the present invention. The top portion shows current standard measurements provided to the consumer for a jacket under present practice, which includes length, bust, and standardized sizing (e.g. sizes 00-6XL), and designations such as petite or regular. As noted above, these types of sizing guidelines vary widely by manufacturer, and often fail to account for particular unique body proportions in the population.

The lower portion of FIG. 2 illustrates, as noted above, additional measurements to be used under the present invention. For the example of a jacket, such measurements may include the armpit across the upper arm, armpit-to-armpit, cuff, and shoulder to hem. Of course, other measurements may be utilized as well, within the scope of the invention, and these measurements are in addition to, rather than a replacement for, the standardized sizing and measurements shown in the upper portion of FIG. 2. Additional measurements will be added as necessary as style trends and clothing design require.

Referring again to FIG. 1, the lower two text boxes 25 and 30 describe the function of the database and associated analysis, in terms of providing useful matching clothing recommendations for particular clients. In particular, the database is analyzed, using appropriate algorithms, in order to make recommendations for clothing available for purchase to consumer profiles with matching data. Crowd-sourced data provides new metrics for the fashion industry concerning what consumers truly want and what they wear. The consumer profile is run against manufacturer, retailer, reseller, and crowd-sourced data to identify the best matches and consumers are alerted, when matches are determined, with appropriate purchasing recommendations. These alerts may be provided via push notifications, through a mobile phone application, text, email, or otherwise in accordance with consumer preference. Some consumers may simply opt for web access to their account, so that they may view their recommendations at their leisure, when they are in the market for clothes. The system may also permit listings created by consumers for sale to other consumers, using the matching algorithms, which may also be subject to the notification process, should a user opt in for such a service.

Thus, what is described herein is a personalized, curated, custom shopping catalog, based on fit profile and preference data in each customer's account. A user is able to search by clothing category, at will, to populate a personalized shopping experience in which all items curated are already vetted as fit options for the user. Other possibilities within the scope of the invention is to curate such a catalog for other purposes, such as for reduced rate purchases from a specific brand, store, or combination of previously matched items (sale pricing curation), a brand-specific catalog, or a personalized catalog that is store specific with multiple brands.

While the invention has been discussed herein as being applicable to clothing, this system may be modified and used for other purposes as well, such as skincare and cosmetics, for example. The applicability of this matching service extends to any product wherein individualized, detailed and personalized data concerning consumer preference and body type will enable a much improved and applicable search through associated product databases for suitable and preferred products.

Therefore, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention, which is to be limited only in accordance with the following claims.

What is claimed is:

1. A method for providing a user with a selection of available articles which most closely match a set of criteria provided by the user, comprising:
providing to a user an input interface identifying a set of criteria to be used to develop the selection of available articles;
collecting data responsive to the set of criteria and input by the user in the input interface and establishing a user profile therefrom;
comparing the user profile to data in a database regarding available articles;
selecting particular ones of the available articles which most closely match the data in user profile; and
preparing and transmitting to the user a communication concerning the selection of available articles.

2. The method as recited in claim 1 wherein the articles comprise articles of clothing.

3. The method as recited in claim 2, wherein the set of criteria comprises a set of specified measurements and sizing information.

4. The method as recited in claim 1, wherein the set of criteria comprises one or more of reduced prices for articles of a specific brand, from a specific store or chain of stores, or from a combination of previously matched items.

5. The method as recited in claim 1, wherein the set of criteria comprises one or more specific article brands.

6. The method as recited in claim 1, wherein the set of criteria comprises a plurality of article brands sourced from a particular store or chain of stores.

7. The method as recited in claim 1, wherein the input interface is displayed on a screen of a personal computer or communications device.

8. The method as recited in claim 1, wherein the communication is transmitted to the user by push notifications through a mobile phone application, text, email, or via an alert message on a website account.

9. The method as recited in claim 3, wherein the set of specified measurements and sizing information includes one or more of favorite clothing item measurements or sizes and body measurements.

10. The method as recited in claim 9, wherein clothing item and body measurements comprise a distance between a user's armpit across their upper arm.

11. The method as recited in claim 9, wherein clothing item and body measurements comprise a distance from armpit-to-armpit on a user.

12. The method as recited in claim 9, wherein clothing item and body measurements comprise a bottom hem width for a user.

13. The method as recited in claim 9, wherein clothing item and body measurements comprise a sleeve inseam measurement for a user.

14. The method as recited in claim 9, wherein clothing item and body measurements comprise a shoulder to bottom hem front measurement for a user.

15. The method as recited in claim 9, wherein clothing item and body measurements comprise a shoulder to bottom hem back measurement for a user.

16. The method as recited in claim 9, wherein clothing item and body measurements comprise the widest section of a breast measurement for a user.

17. The method as recited in claim 9, wherein clothing item and body measurements comprise a specific band height measurement for a user.

18. The method as recited in claim 9, wherein clothing item and body measurements comprise a specific measurement across a widest part of a leg opening for a user.

19. The method as recited in claim 1, and further comprising crowdsourcing data from a plurality of users to populate the database.

20. The method as recited in claim 1, and further comprising collecting data from market sources of the articles to populate the database.
